(19) United States
(12) Patent Application Publication
(10) Pub. No.: US 2014/0105813 A1
(43) Pub. Date: Apr. 17, 2014

(54) HYDROGEN RECYCLER WITH OXYGEN REACTOR

(71) Applicants: Robert S. Hirsch, Troy, NY (US); Glenn A. Eisman, Niskayuna, NY (US); Charles M. Carlstrom, Saratoga Springs, NY (US)

(72) Inventors: Robert S. Hirsch, Troy, NY (US); Glenn A. Eisman, Niskayuna, NY (US); Charles M. Carlstrom, Saratoga Springs, NY (US)

(21) Appl. No.: 13/653,491

(22) Filed: Oct. 17, 2012

(51) Int. Cl. C01B 3/02; B01J 7/00

(52) U.S. Cl. 423/648.1; 422/129; 422/119

(57) ABSTRACT

A hydrogen recycling system for a controlled atmosphere unit operation with an exhaust vent and an inlet port includes: a hydrogen recycle unit in fluid communication with the exhaust vent and in fluid communication with the inlet port; and an oxygen reactor being located between the controlled atmosphere unit operation and said hydrogen recycle unit and in fluid communication with the controlled atmosphere unit operation and said hydrogen recycle unit.

### FIELD OF THE INVENTION

The instant invention is directed to a hydrogen recycler used with, for example, a controlled atmosphere unit operation, e.g., a furnace.

### BACKGROUND OF THE INVENTION

In many industrial processes, controlled atmospheres are utilized to expose, for numerous reasons, products and/or materials to specific atmospheres other than the natural (or ambient) atmosphere. In some of these processes, a reducing atmosphere is desired to prevent oxidation of the products/materials being processed (i.e., provide an oxygen-free environment). These controlled atmospheres may utilize hydrogen, alone or with other gases, for this purpose. Controlled atmosphere processes include, by way of non-limiting example: metal processing (including annealing, sintering, brazing, hardening, and as protective blankets in welding). Float glass production where controlled atmospheres prevent oxidation of the molten metal bath and can facilitate removal of impurities. Semiconductor production where controlled atmospheres, e.g., hydrogen, again may be used to prevent formation of contaminants arising from oxidation. Alternatively, controlled atmospheres may be used to provide a reactant for a reaction, for example, in hydrodealkylation, hydrodesulfurization, hydrocracking, and hydrogenation of fats and oils. Furthermore, there are processes that generate hydrogen as a reaction by-product, for example, the chlor-alkali process to produce caustic soda and chlorine.

In many of the foregoing examples, excess (or unreacted) or generated hydrogen is not captured and recycled, especially for low to moderate volumes of hydrogen. In these processes, any excess (or unreacted) hydrogen may be merely vented to the ambient atmosphere or burned in a flare. Hydrogen, however, is a commodity that is purchased (or generated on-site). In controlled atmosphere unit operations, the hydrogen must flow through the process to maintain a ‘fresh’ oxygen-free environment, sweeping out any impurities generated in the process. Regardless of the source, merely venting excess (or unreacted) hydrogen is a cost to production and just becomes a valuable, wasted asset. Therefore, if all or a part of the excess (or unreacted) hydrogen could be captured and recycled or reused for other hydrogen-intensive processes, savings could be realized.

One such recycling scheme has been proposed, see US2009/0176180 and US2010/0243475, incorporated herein by reference. Therein, a hydrogen recycle system is utilized to capture and recycle hydrogen back to the process (or into other on-site hydrogen intensive processes). This scheme has met with success.

In the development of the foregoing hydrogen recycle scheme, it has been discovered that oxygen, from any source (including ambient air may infiltrate the feed line of the recycling unit. This oxygen infiltration may be detrimental to the operation of the hydrogen recycle unit, and if high enough in concentration, may produce an unsafe condition in downstream, secondary unit operations of the recycler. In addition, too much oxygen will cause excess reaction of hydrogen that otherwise would be recycled, leading to an inefficiency. It is therefore desirable to limit the amount of oxygen drawn into the hydrogen recycling unit.

Therefore, there is a need to detect and eliminate or reduce oxygen in the feed line of the hydrogen recycle unit.

### SUMMARY OF THE INVENTION

A hydrogen recycling system for a controlled atmosphere unit operation with an exhaust vent and an inlet port includes: a hydrogen recycle unit in fluid communication with the exhaust vent and in fluid communication with the inlet port; and an oxygen reactor being located between the controlled atmosphere unit operation and said hydrogen recycle unit and in fluid communication with the controlled atmosphere unit operation and said hydrogen recycle unit.

### DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 is a schematic illustration of one embodiment of the hydrogen recycling system.

FIG. 2 is a schematic illustration of one embodiment of the oxygen reactor and its sensors.

FIG. 3 is a schematic illustration of another embodiment of the oxygen reactor and its sensors.

FIG. 4 is a schematic illustration of yet another embodiment of the oxygen reactor and its sensors.

### DESCRIPTION OF THE INVENTION

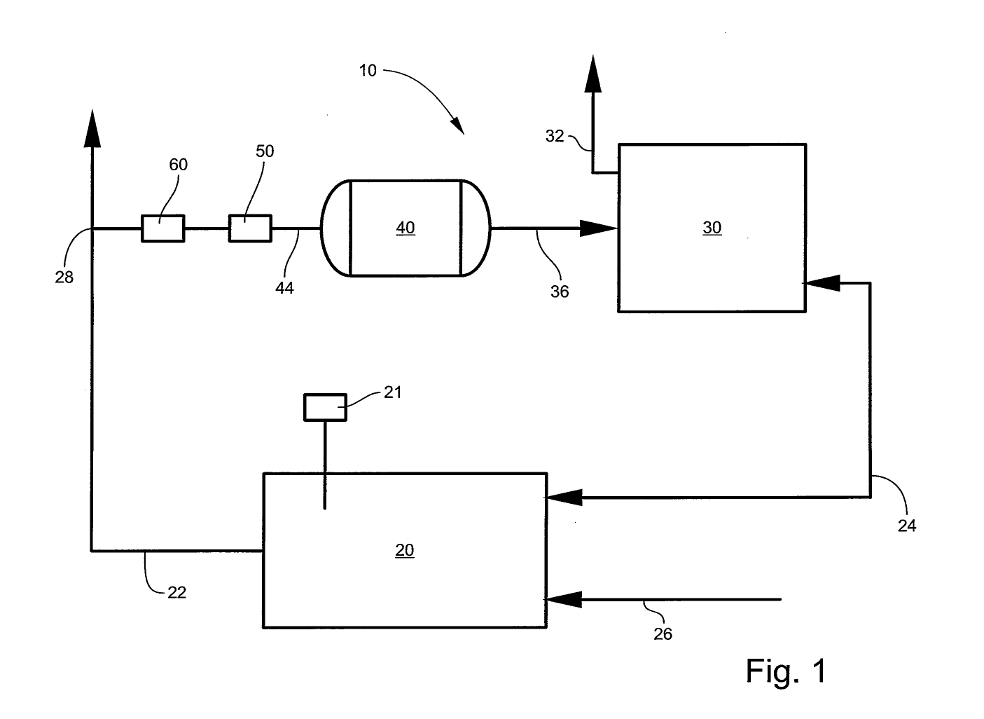

Referring to the drawings, where like numerals indicate like elements, there is shown in FIG. 1 a hydrogen recycling system 10 in use with a controlled atmosphere unit operation (for example, a controlled atmosphere furnace) 20. In general, system 10 includes a hydrogen recycling unit 30, an oxygen reactor 40, and optionally, a contaminant collection system 50 and/or oxygen testing port 60. Gases, including hydrogen, (these gases may be virgin, recycled, or a combination of both) may be fed to furnace 20 via line 26 (and/or line 24). Furnace 20 expels its exhaust gases through an exhaust vent 22. The exhaust vent 22 maybe vented to the atmosphere or to a flare. A take-off port (or ‘tee’) 28 is placed along exhaust vent 22. Oxygen reactor 40 is coupled to and in fluid communication with tee 28 via line 44. Hydrogen recycle unit 30 is coupled to and in fluid communication with oxygen reactor 40 via line 36. Waste is exhausted from hydrogen recycle unit 30 via line 32. Hydrogen produced from the hydrogen recycle unit 30 is recycled back to the furnace 20 via line 24. While the present invention is described in conjunction with a controlled atmosphere furnace, it is not so limited and may be used in any unit operation having a need to recycle and then reuse excess (or unreacted) hydrogen as will be evident to those of ordinary skill. Accordingly, unit operation may be substituted for furnace throughout this specification. Furthermore, additional fluid communication configurations may be evident to those of ordinary skill.

In operation, virgin gas, including hydrogen, may be fed to furnace 20 via line 26. Exhaust gas leaves the furnace 20 via exhaust vent 22. Exhaust gas is drawn from vent 22 through tee 28 via a pump/fan/blower (not shown) in line 44 to oxygen reactor 40. Oxygen is removed or reduced in reactor 40. The exhaust from reactor 40 is moved to hydrogen recycle unit 30 via line 36. The pump/fan/blower may be contained in (or a part of) the recycle unit 30.

Controlled atmosphere furnace 20 (or reduction atmosphere oven) may be coupled with the hydrogen recycle system 10. Controlled atmosphere furnace 20 may be used in various heating treating operations where oxidation needs to be prevented or minimized. The controlled atmospheres of these furnaces may include hydrogen, or a combination of hydrogen and nitrogen, or other combinations of other gases with hydrogen. The hydrogen is typically purchased (or generated upstream of the controlled atmosphere furnace), supplied to the furnace, and vented to the atmosphere without any recycle. This is a waste of expensive hydrogen. For example, in metal processing, controlled atmosphere furnaces may be used in annealing, sintering, brazing, or hardening operations. In metal production, hydrogen is commonly used to reduce the ore to metal. In float glass production, controlled atmosphere furnaces may be used to prevent oxidation of the metal baths. In semiconductor manufacture, controlled atmosphere furnaces are used during the manufacture and processing of silicon wafers in the production of integrated circuits (IC) chips. The controlled atmosphere furnace is but one example of a unit operation where a controlled atmosphere may be utilized. Thus, wherever a controlled atmosphere unit operation utilizing hydrogen is used, the instant recycling system may be employed. But, the unit operation need not be limited to just furnaces; the system may also be employed wherever a controlled atmosphere including hydrogen may be needed. Such processes may include numerous semiconductor processes, extraction of hydrogen from pipelines, extract hydrogen from electrolytic and chemical processes, and the like. The system may also be employed in hydrogenation processes, for example, in hydrodealkylation, hydrodesulfurization, hydrocracking, and hydrogenation of fats and oils. The system may also be employed in processes that generate hydrogen as a by-product. Accordingly, while the instant invention is described as being used with a controlled atmosphere furnace, it is not so limited, and it may be employed wherever quantities of hydrogen are used (or produced) and not fully utilized (e.g., consumed) as a means to produce a reduction atmosphere, a protective blanket, a reactant, or a by-product of a reaction, as those of ordinary skill will understand.

Hydrogen recycle unit 30 may be any apparatus or process capable of separating hydrogen from a mixture of gases. In one embodiment, the hydrogen recycle unit 30 may utilize an electrochemical hydrogen pump. Electrochemical hydrogen pumps are known, for example see: US2009/0176180; US2010/0243475; US2004/0028960; US2003/0196893; US2007/0193885; US2007/0227900; US2007/0246373; US2007/0246363; US2007/0246374; and US2008/0121532, each of which is incorporated herein by reference. For example, in an electrochemical cell utilizing a proton exchange membrane, the membrane is sandwiched between a first electrode (anode) and a second electrode (cathode). A gas containing hydrogen is supplied to the first electrode. An electric potential is placed between the first and the second electrodes. The first electrode's potential with respect to ground (or zero) is greater than the second electrode's potential with respect to ground. Each hydrogen molecule reacted at the first electrode produces two protons which are driven through the membrane by the applied electric field to the second electrode of the cell, where they are rejoined by two electrons to reform the hydrogen molecule (sometimes referred to as ‘evolving hydrogen’ at the electrode). Other methods to recycle hydrogen may also be used and benefit from the instant invention, including methods by which hydrogen is compressed and processed by mechanical compressors and then cleaned up using pressure swing adsorption clean up systems.

Oxygen reactor 40 may be any reactor capable of removing oxygen from the gas stream. In one embodiment, the oxygen reactor 40 converts oxygen and hydrogen to water. The oxygen reactor 40 is placed between the exhaust vent 22 and the hydrogen recycled unit 30. In one embodiment, the oxygen reactor 40 is placed in line between a tee 28 in the exhaust vent 22 and the hydrogen recycle unit 30. In yet another embodiment, the tee 28 should be placed away from the furnace to allow the gas time to cool in the line. In one embodiment, the oxygen reactor 40 may be placed in line 44 adjacent to or proximal to the tee 28. In another embodiment, oxygen reactor 40 should not be placed in the exhaust vent 22, as it could block the exhaust vent causing a pressure increase that may lead to gas leakage from the furnace.

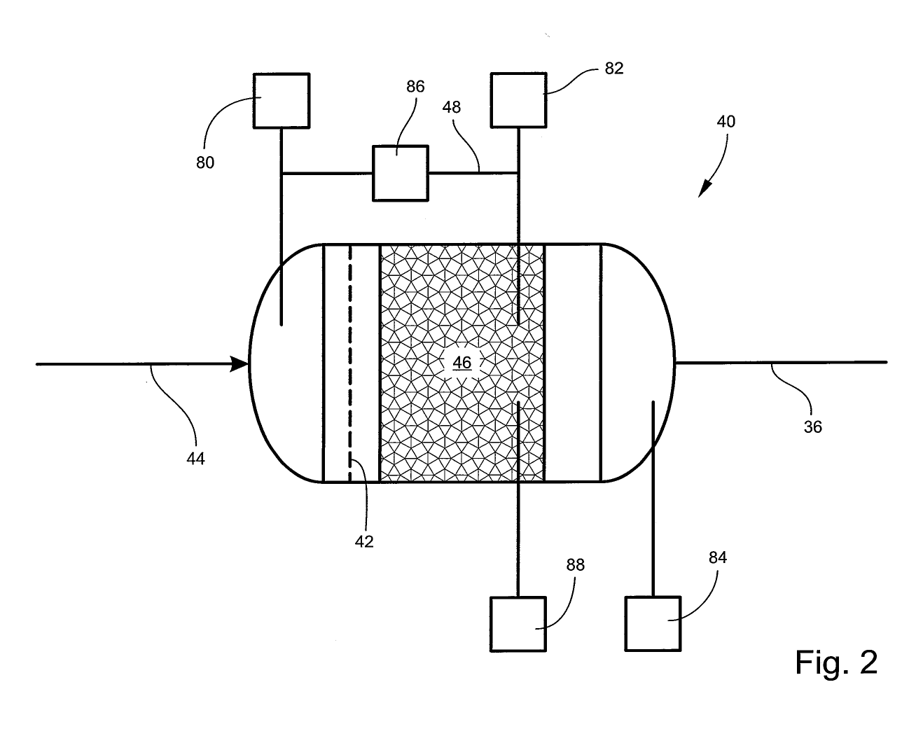

Oxygen reactor 40 may also include a diffuser plate 42 (FIG. 2). Plate 42 may be located adjacent to or proximal the inlet of reactor 40. Plate 42 is used to ensure the even distribution of gas through the active material 46 of reactor 40, discussed below.

Oxygen reactor 40 may be used to detect and eliminate or reduce oxygen in the feed line of the hydrogen recycle unit 30. Excess oxygen in the line may lead to explosive conditions; therefore, it may be best to eliminate or reduce oxygen in the line prior to the hydrogen recycle unit 30. This oxygen may enter the system from the atmospheric end of the exhaust vent 22 as the exhaust gas is drawn from the exhaust vent to supply the hydrogen recycle unit 30. It may also enter the vent line 22 from other sources, including the furnace itself (e.g., when the furnace is not operating properly or during start-up).

Oxygen reactor 40 may also be used to control inflow into the oxygen reactor or shut inflow off. Sensors, discussed below, in communication with the reactor 40 may be used to control the inflow of the exhaust into the reactor 40 and on to the recycle unit 30, or shut down all flow to the reactor 40 and recycle unit 30, if, for example, too much oxygen is present. Several exemplary embodiments of the reactor 40, its sensors, and its operation are discussed below. It should be understood that the sensors discussed below may be used separately or in various combinations.

In FIG. 2, one embodiment of oxygen reactor 40 illustrated. Oxygen reactor 40 may include an active material 46 to facilitate removal of oxygen. Active material 46 may be a catalyst to facilitate the reaction of hydrogen and oxygen to form water. Any known catalyst may be used. Alternatively, active material 46 may be an absorbent or adsorbent to facilitate removal of oxygen.

Reactor 40 may also include a first temperature sensor 80 located, for example, at the inlet side of the reactor and a second temperature sensor 82 located, for example, downstream of the first temperature sensor 80 (and in this embodiment in the catalyst). These temperature sensors 80/82 may be used to control (via any method including microprocessors or computers), for example, exhaust flow into the reactor 40 and/or the rate of the reaction in reactor 40. In operation, as oxygen and hydrogen react, the temperature at sensor 82 will increase relative to the temperature at sensor 80. This temperature increase is related to the concentration of oxygen in the incoming hydrogen stream. The temperature differential and/or the rate of change in the temperature differential may be used to control, for example, the flow of gas in line 44 entering reactor 40. For example, if the control circuit determines that the temperature difference or the rise in temperature is too great, the control circuit may instruct a pump/fan/blower (not shown) in recycler or line 44 to slow the draw of exhaust gas from vent 22. Additionally, if the temperature difference or the rise in temperature is too great, the control circuit may instruct the pump/fan/blower to shut off exhaust gas to the oxygen reactor 40. Conversely, if the temperature difference is too low, the system may challenge itself by, for example, changing the exhaust inflow. By so doing, the system, by observing the exit conditions, may re-set the pertinent control parameters. Instead of reducing the inlet flow by using the pump/fan/blower, the controller could instead, or in combination, reduce the current to the electrochemical pump, thereby reducing the flow to the system.

Optionally, an oxygen sensor 84 may be located at the exit end of the reactor 40 (FIG. 2). This oxygen sensor 84 may be used to determine if the active material 46 needs to be serviced. Sensor 84 may be an electrochemical oxygen sensor.

Optionally, an oxygen sensor 86 may be place, for example, in a slip stream 48, between temperature sensors 80/82. Sensor 86 is provided as a redundancy. Gas flow through sensor 86 may be caused by the pressure drop between the sensors 80/82 and/or facilitated by a pump (not shown).

Optionally, a third temperature sensor 88 may be located off-center in the reactor 40 to check that diffuser plate 42 is operating as intended.

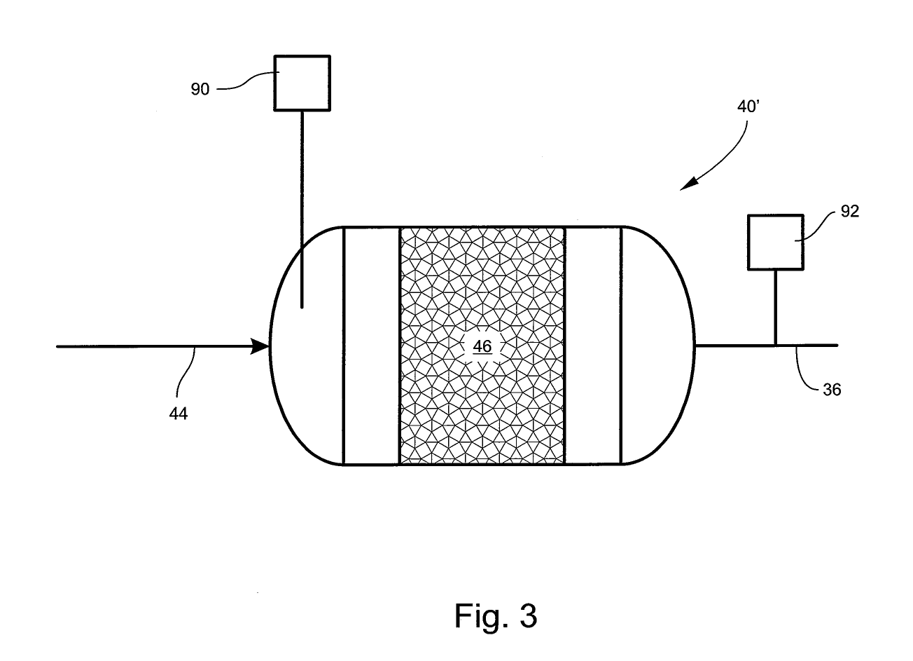

In another embodiment (FIG. 3), an oxygen sensor 90 is located upstream of reactor 40′ and a moisture sensor 92 is located downstream of reactor 40′. In flow of exhaust (and/or rate of reaction) may be controlled (e.g., via any method including microprocessor or computer) by information from the oxygen sensor 90 and the moisture sensor 92. For example, the amount of incoming oxygen may be measured by oxygen sensor 90. The amount of reacted oxygen may be determined from the moisture sensor 92 (dew point). The dew point of the exit gas would indicate that a reaction between oxygen and hydrogen took place and the extent of that reaction. For example, the dew point of the exiting gas would be directly related to the oxygen concentrations at the inlet port according to a psychrometric chart. With this information, the operation of reactor 40′ (including rate of inflow and/or rate of reaction) may be controlled. If necessary, for example, should insufficient oxygen be removed, the reactor exhaust may be recycled through reactor 40′.

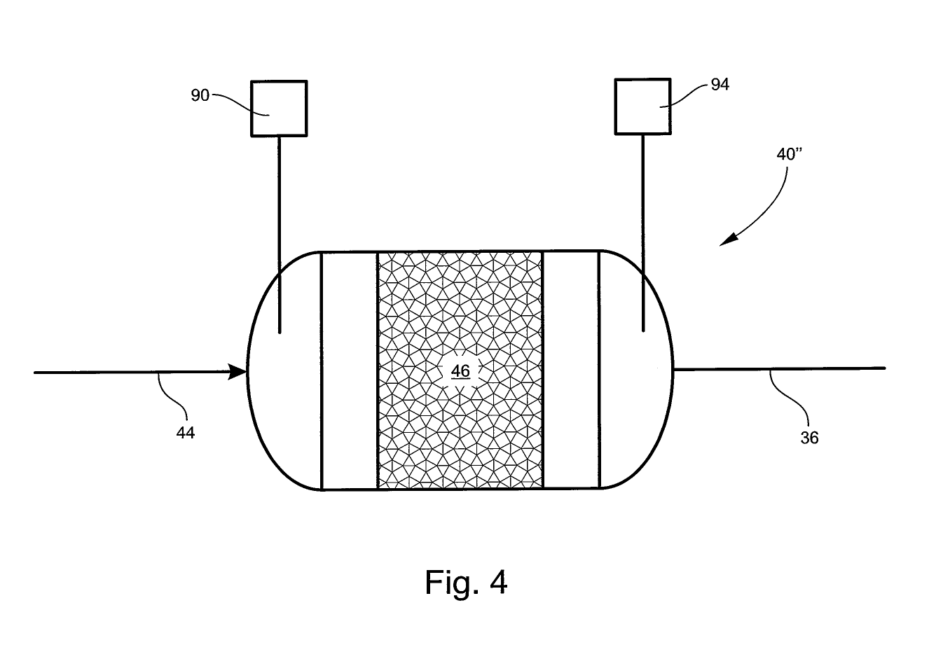

In another embodiment (FIG. 4), an oxygen sensor 90 is located upstream of reactor 40″ and a pressure sensor 94 is located downstream of reactor 40″. Inflow of exhaust (and/or rate of reaction) may be controlled (via any method including microprocessor or computer) by information from the oxygen sensor 90 and the pressure sensor 94. For example, the amount of incoming oxygen may be measured by oxygen sensor 90. The amount of reacted oxygen may be determined from the pressure sensor 94. With this information, the operation of reactor 40″ (including rate of inflow and/or rate of reaction) may be controlled. If necessary, for example, should insufficient oxygen be removed, the reactor exhaust may be recycled through reactor 40″. Alternatively, the pressure sensor could be used to determine if the oxygen reactor has been clogged.

In another embodiment, a sensor may be used to determine if too much exhaust is being drawn from the unit operation. For example, the furnace is operated at certain specific conditions so that the desired reaction or environmental condition is maintained. Thus, while recycling of hydrogen is good, drawing too much from line 22 may effect the pressure and therefore upset the unit operation conditions. To prevent this, the output of a pressure sensor 21 (FIG. 1) in the unit operation may be used as a control signal. If the pressure change at the unit operation is too great, then the recycle system may adjust, via the pressure sensor signal, the draw of exhaust to compensate for the pressure change.

Optionally, a contaminant collection system 50 is located upstream of oxygen reactor 40 (FIG. 1). Collection system 50 may be used to extend the life of the reactor by, for example, preventing foreign material (physical materials, e.g., liquids and solids), such as furnace glass and oil, from clogging the oxygen reactor. For example, oils and particulate coming from the unit operation 20 may occlude or deactivate the active material 46 in the reactor 40. In certain heat treating operations, furnace glass built up on vent walls has been observed in relatively short time frames. The collection system may be a ‘tee,’ a series of impingement plates (for example, disposed in line 44 so as to create a serpentine flow path of the exhaust), a screen, or a filter. The screen may be pleated to attain a high surface area or it can be designed to self clean. A self cleaning screen would minimize or potentially eliminate the service interval needed to maintain the oxygen reactor. In one embodiment, the screen may be designed to buckle (or ‘oil can’). The oil canning effect would clear debris that builds up on the screen during operation. This configuration used with a thermal actuator would enable it to self clean every time the oxygen reactor/recycler is not performing to specification or actually shuts down.

Optionally, a test port 60 is located upstream of oxygen reactor 40 (FIG. 1). Port 60 may be used to inject a known amount of oxygen into the system to check the operation of reactor 40 and the activity of the active material 46. Port 60 may be located at the inlet of reactor 40, in the tee 28, in line 44, and/or vent line 22.

The present invention may be embodied in other forms without departing from the spirit and the essential attributes thereof, and, accordingly, reference should be made to the appended claims, rather than to the foregoing specification, as indicating the scope of the invention.

We claim:

1. A hydrogen recycling system for a controlled atmosphere unit operation with an exhaust vent and an inlet port comprising:
a hydrogen recycle unit in fluid communication with the exhaust vent and in fluid communication with the inlet port; and
an oxygen reactor between the controlled atmosphere unit operation and said hydrogen recycle unit.

2. The hydrogen recycling system of claim 1 wherein said oxygen reactor being adapted to remove oxygen from a gas stream entering the hydrogen recycle unit.

3. The hydrogen recycling system of claim 1 wherein said oxygen reactor being adapted to control a gas stream flowing into said oxygen reactor.

4. The hydrogen recycling system of claim 1 wherein a tee in the exhaust vent places the exhaust vent in fluid communication with the hydrogen recycle unit.

5. The hydrogen recycling system of claim 4 wherein said oxygen reactor being located between said tee and said hydrogen recycle unit.

6. The hydrogen recycling system of claim 1 wherein said oxygen reactor converts oxygen and hydrogen to water.

7. The hydrogen recycling system of claim 6 wherein said oxygen reactor further comprises a catalyst to facilitate the reaction of oxygen and hydrogen to form water.

8. The hydrogen recycling system of claim 1 wherein said oxygen reactor adsorbs or absorbs oxygen.

9. The hydrogen recycling system of claim 1 further comprising a sensor in communication with said oxygen reactor for controlling inflow into said oxygen reactor or shutting inflow off.

10. The hydrogen recycling system of claim 9 wherein said sensor being a temperature sensor, an oxygen sensor, a moisture sensor, or any combination thereof.

11. The hydrogen recycling system of claim 1 wherein the unit operation being a furnace.

12. The hydrogen recycling system of claim 1 further comprising a contaminant collection system located upstream of said oxygen reactor.

13. The hydrogen recycling system of claim 12 wherein said contaminant collection system being a screen.

14. The hydrogen recycling system of claim 13 wherein said screen being a self cleaning screen.

15. The hydrogen recycling system of claim 1 wherein said oxygen reactor includes a diffuser.

16. A method for controlling gas flow to a hydrogen recycler used with a controlled atmosphere unit operation, the hydrogen recycler including an oxygen reactor, comprising the steps of:
comparing an first gas condition before the oxygen reactor to a second gas condition after or in the oxygen reactor, and
controlling gas flow to the hydrogen recycler based upon the comparison.

17. The method of claim 16 wherein the first gas condition and the second gas condition being selected from the group consisting of: temperature, oxygen concentration, humidity, pressure, or a combination thereof.

18. The method of claim 16 wherein comparing further comprises
monitoring a first gas temperature before the oxygen reactor,
monitoring a second gas temperature downstream of the first gas monitor, and
comparing the first and second gas temperatures, whereby if a difference between the first and second temperatures or a rate of change in the first and second gas temperatures being greater than a predetermined value, then slowing or stopping gas flow, and if a difference between the first and second gas temperatures being less than a predetermined value, then increasing gas flow.

19. The method of claim 16 wherein comparing further comprising
monitoring a gas oxygen concentration before the oxygen reactor, and
monitoring a dew point downstream of the gas oxygen concentration monitor.

20. The method of claim 16 wherein comparing further comprising
monitoring a gas oxygen concentration before the oxygen reactor, and
monitoring a pressure down downstream of the gas oxygen concentration monitor.

21. The method of claim 16 wherein controlling further comprising
changing a gas flow rate into the hydrogen recycler or hanging an operating condition of the hydrogen recycler.

22. A method for controlling the gas flow to a hydrogen recycler for a controlled atmosphere unit operation, the hydrogen recycler having an oxygen reactor, comprising the steps of:
monitoring pressure change in the unit operation, and
controlling gas flow the hydrogen recycler based upon the pressure change.
